(19) United States
(12) Patent Application Publication
(10) Pub. No.: US 2015/0378622 A1
(43) Pub. Date: Dec. 31, 2015

(54) MANAGEMENT OF DATA OPERATIONS

(71) Applicant: Hewlett-Packard Development Company, L.P., Houston, TX (US)

(72) Inventors: Nathaniel S. DeNeui, Houston, TX (US); Jeff W. Wolford, Spring, TX (US)

(21) Appl. No.: 14/320,188

(22) Filed: Jun. 30, 2014

(51) Int. Cl. G06F 3/06

(52) U.S. Cl. CPC G06F 3/0619; G06F 3/0689; G06F 3/0665

(57) ABSTRACT

In response to receipt of host data operation requests associated with logical unit numbers (LUNs) of storage devices, send host data operation commands to the LUNs associated with the storage devices. Upon entering a background time period, allowing completion of host data operations associated with the host data operations commands sent to the storage devices. During the background time period, store in a storage queue any host data operation commands during the background time period and not send any host data operation commands to LUNs associated with the storage device, instead send background data operation commands to LUNs associated with the devices. Upon expiration of the background time period, retrieve host data operations commands previously stored on the storage queue, and send the retrieved host data operation commands to the LUNs associated with the storage devices, and not sending background data operation commands to LUNs associated with the devices.

### BACKGROUND

Computer systems may include host computers coupled to storage systems with storage controllers to manage access to storage on storage arrays. A storage array comprises physical storage devices presented to the host as logical storage space. The host may generate data operation requests to read data from the storage array and return the data back to the host. The host may also generate data operation requests to write data from the host to the storage array.

### BRIEF DESCRIPTION OF THE DRAWINGS

FIG. 1 is a block diagram of a computer system for management of data operations according to an example implementation.

FIG. 2 is a flow diagram for management of data operations according to an example implementation.

FIG. 3 is a timing diagram of management of data operations according to an example implementation.

FIG. 4 is an example block diagram showing a non-transitory, computer-readable medium that stores instructions for a computer system for management of data operations in accordance with an example implementation.

### DETAILED DESCRIPTION

Computer systems may include host computers coupled to storage systems with storage controllers to manage access to storage on storage arrays. The storage array comprises physical storage devices presented to the host as logical storage space or logical unit numbers (LUNs). The hosts may generate data operation requests to read data from the storage array and return the data back to the host. The hosts may also generate data operation requests to write data from the hosts to the storage array. In response to receipt of the data operation requests, the storage controller may generate host data operation commands to perform host data operations directed to the storage array. The host data operations include operations to exchange data between the storage array and the hosts. For example, the operations may include operations for reading data from the storage array and returning it to hosts. In another example, the operations may include operations for writing data from the hosts to the storage array. The host data operation commands may include commands to access data, including instructions to storage and retrieval of data, in a sequential manner, random manner or a combination thereof.

In addition to host data operation commands, the storage controller may generate background data operation commands to perform background data operations such as sequential data operations directed to the storage array. In one example, sequential data operations may be part of rebuild or reconstruction operations of a redundant storage array configured as redundant array of independent disks (RAID) that has encountered a disk failure. In one example, RAID is a data storage virtualization technology that combines multiple disk drive components into LUN for purposes of data redundancy or performance improvement. It is desirable for the storage controller to be capable of managing both host data operations and background data operations to help improve overall performance of the storage system.

The techniques of the present application are described in the context of sequential data operations. However, it should be understood that the techniques of the present application may be applicable to other modes of processing or accessing data or data operations. For example, the techniques of the present applications may be applicable to any storage media besides disk drives which may be accessed using sequential as well as a random data operations. That is, these techniques maybe applicable to physical devices other than disk drives with spinning technology. For example, these techniques may apply to storage technology with different optimal access patterns such as for Flash, Memristor and the like. The techniques may allow for I/O activity that may be more directed to the type of physical storage medium being used. That is, these techniques may be able to handle IO activity for commands to access data, including instructions for storage and retrieval of data, in a sequential manner, random manner or a combination thereof. For example, the techniques may be able to handle storage medium or technology such as Flash memory in which case the access patterns or data operations that may be random in nature.

In some examples of the present application, techniques are disclosed which may manage both host data operations and background data operations to help improve overall performance of the storage system. For example, the techniques may provide a data operations management module that includes a storage device queue having a depth or capacity that may be adjusted to store entries representing both background data commands and host data commands. The management module may be configured to provide background time periods to allow background data operations to be exclusively performed while host data operations commands are queued or stored in the storage device queue.

In some examples, the data operation management module may be configured to repeat or provide multiple background time periods until completion of background operations are performed on the storage devices. In one example, host data operation commands may include commands to exchange data between the host and the storage devices. In another example, background data operation commands may include commands to perform sequential data operations on the storage devices. In another example, data operations management module may adjust periodicity of the background time period and length of the background time period based on characteristics of host data operations and background data operations.

In one example, storage controller may generate background time periods to allow background data operations to be exclusively performed. For example, background data operations may include sequential data operations associated with disk rebuild operations for a LUN configured on a storage controller to perform data rebuild operations in a sequential manner over time. A LUN identifies a specific logical unit of a storage array which consists of multiple physical storage devices, such as hard disk drives, and present the physical storage devices as logical storage space. The disk rebuild operations may include reconstruction operations to restore a storage array configured with redundancy such as RAID configurations back to a redundant state after a disk failure error. The background time periods may allow for background data operations access to the storage devices to be partitioned into exclusionary periods, along with host data operations outside of the exclusionary background time periods. The sequential operation allows two conflicting patterns of requests such as background and host data operations with each type of operation having exclusive access to the disk drives. That is, during background time periods, only background data operations may be performed and, then after or outside of the background time periods, the host data operations may be performed. This may reduce having storage arrays from performing additional seeks for a hard drive which may otherwise result in lower performance for both operations.

The techniques of the present application may provide for more granular priority settings of processing background data operations which may help maintain redundancy of a storage array configured as part of a RAID configuration. These techniques may help perform background operations to regenerate or rebuild redundancy in a faster manner which may help reduce possibility of a double-fault scenario where user data may be lost. Double-fault scenario may occur when two disk drives encounter disk faults which may make error recovery difficult. These techniques may help increase overall performance of background operations performed by the storage controller. This may be possible when the storage array is configured for RAID by having the storage controller cease or stop host data operations to the storage device, such as hard disk, for a period of time. These techniques may improve performance of host data operations in normal host operation periods by preventing background data operations from causing additional seek hard disks actions during the host operation periods. The techniques of the present applications are described in the context of a double-fault scenario which is applicable to a RAID-5 configuration. However, it should be understood that techniques of the present application may be applicable to other fault scenarios including scenarios covering multiple levels of protection. For example, these techniques may be applicable to triple-fault scenarios for a RAID-6 configuration having additional parity drives. In this case, the other parity drives may not be processed because of the additional processing in generating the additional parity data, decreased data storage “efficiency” and lower probability of triple/quad level fault.

In some examples of the present application, techniques are disclosed to manage both host data operations and background data operations to help improve overall performance of the storage system. The techniques may include permitting data operations over three operational or behavior periods. During a first operational period, starting from normal host data operations, where the storage controller is sending host data operation commands from the host to the LUN of a storage device, the controller enters a background time period, where outstanding host data operations are allowed to complete. However, during this transition period spanning from the end of the host time period to the beginning of the background time period, the storage controller may not generate or issue any new host data operation commands. Instead any such new host data operation commands are stored or placed on a storage device queue to be retrieved at a later time. During this background time period, the storage controller exclusively generates and submits background data operation commands to the storage devices of the storage array.

During a second operational period, that is, upon the completion of any final outstanding host data operations to the last targeted storage device in the LUN, the storage controller initiates a relatively short background time period, where the storage controller exclusively generates or submits background data commands to perform background data operations on the storage devices of the storage array. At this point, assuming the storage devices are hard disk drives, the disk drives will respond to seek operations associated with the background data operations, which are usually adjacent.

During a third operational period, at the end or upon exit of the background time period, the storage controller may retrieve any host data operation commands that were previously queued or backed up onto the storage device queue. Then, the storage controller submits the retrieved host data operation commands as the storage controller resumes normal host data operations.

In one example, the storage controller may configured to continue to perform the above process in a periodic manner by generating multiple background time periods until the specified background operation is performed. For example, the background operation may correspond to a rebuild or reconstruction operation to restore redundancy to a storage array configured as a RAID that encountered a disk failure. In another example, the storage controller may continue to perform the above process in a periodic manner if the priority of the operations is adjusted downward. In one example, characteristics of the data operations may increase the priority which in turn may increase the periodicity or frequency of the background time period and the length of the background time period.

In some examples, these techniques may improve system performance or behavior. For example, the storage controller may provide increased performance of host data operations at higher storage device queue depths which may increase or surpass performance that may otherwise be reduced or lost by the background time period. In this case, the storage controller may reduce the need to offload or defer requests away from the storage controller corresponding to a degraded logical unit of a storage device as part of a RAID storage configuration. In another example, the storage controller may increase the performance for the background data operations as part of rebuild operations. This may allow for increased protection for the LUN data through increase of the rate at which the regeneration operations (background data operations) may be performed relative to host data operations.

In some examples, the storage controller may manage certain host data operation request patterns that would otherwise inhibit or degrade operations without the need to reduce or cease optimization for those requests. In this case, the storage controller may continue to optimize those operations to help increase performance of the system. In other examples, the storage controller may manage the behavior of the storage devices to help improve performance. In the case where the storage devices are configured as hard disk drives, the storage controller may manage behavior based on disk seek operation related requests submitted by sequentially performing the operations instead of concurrently performing the operations. In this case, the storage controller may cause the hard disk drive to produce higher levels of throughput through its own optimization.

In some examples of the present application, techniques are provided which may manage both host data operations and background data operations to help improve overall performance of the storage system. In one example, disclosed is a storage apparatus for management of data operations. The apparatus includes a storage device queue and a data operation management module to manage data operations. In response to receipt of host data operation requests associated with logical unit numbers (LUNs) of storage devices, the data operation management module may send host data operation commands to the LUNs associated with the storage devices.

Upon entering a background time period, the data operation management module allows completion of host data operations associated with the host data operations commands that were sent to the storage devices. During the background time period, the data operation management module may store in the storage device queue any host data operation commands during the background time period. However, during the background time period, the data operation management module does not send any host data operation commands to LUNs associated with the storage devices. Instead, the data operation management module sends background data operation commands to LUNs associated with the storage devices.

Upon expiration of the background time period, the data operation management module may retrieve host data operations commands previously stored on the storage queue and send the retrieved host data operation commands to the LUNs associated with the storage devices. However, upon expiration of the background time period, the data operation management module does not send background data operation commands to LUNs associated with the storage devices.

In this manner, these techniques may help manage both host data operations and background data operations to help improve overall performance of the storage system.

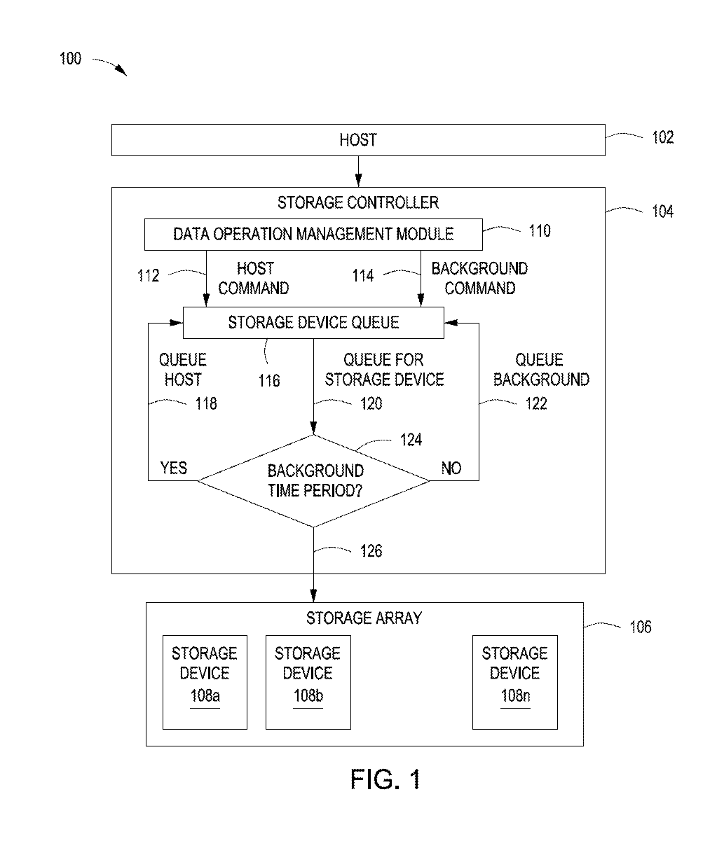

FIG. 1 is a block diagram of a computer system 100 for management of data operations according to an example implementation. The computer system 100 includes a host 102 coupled to a storage controller 104 with a data operation management module 110 to manage data operations between host 102 and storage array 106.

The host 102 may be any electronic device capable of data processing such as a server computer, mobile device and the like. The host 102 may include a host application for managing the operation of the host including communication with storage controller 104. In one example, the host application may include functionality for management of a host file system. The file system may be any electronic means of management of storage and retrieval of data. In one example, file system may store data that may be organized into individual portions and each portion is assigned a name that may be easily separated and identified. In one example, file system may be organized where the portions of data are called files and where the files are organized in a directory or tree structure.

The host application may include functionality to communicate with storage controller 104. For example, host application may be a backup and restore application which may be configured to request that storage controller 104 perform functions to backup and restore data blocks of a file system. As part of a backup operation, host application may send to storage controller 104 host data operation requests to backup specified data blocks of the file system. The host data operation requests may include data blocks of file system which storage controller which will then write as data blocks to storage array 106. As a first part of a restore operation, host application may send to storage controller 104 host data operation requests to cause storage controller to initiate retrieval of particular number of data blocks from storage array 106

It should be understood that the description of host 102 above is for illustrative purposes and other implementations of the host may be employed to practice the techniques of the present application. For example, host 102 is shown as a single component but host 102 may include a plurality of hosts coupled to storage controller 104.

The storage controller 104 may be any electronic device capable of data processing such as a server computer, mobile device and the like. The storage controller 104 includes functionality to communicate with host 102 and storage array 106. The storage controller 104 may communicate with host 102 and storage array 106 using any electronic communication means including wired, wireless, network based such as storage area network (SAN), Ethernet, Fibre Channel and the like.

The storage array 106 includes a plurality of storage devices 108a through 108n configured to present logical storage devices to host 102. In one example, host 102 may access the logical configuration of storage array as LUNS. The storage devices 108 may include any means to store data for later retrieval. The storage devices 108 may include non-volatile memory, volatile memory or a combination thereof. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices 108 include, but are not limited to, hard disk drives, compact disc drives, digital versatile disc drives, optical drives, and flash memory devices.

The storage controller 104 may configure storage array 106 as various possible configurations. For example, assuming that storage devices 108 are disk drives, storage array 106 may configured for striping data across a group, or array, of multiple physical disks such that the controller may present a single logical disk to host 104. In this manner, striping may provide a logical storage space (i.e., LUN) with a larger storage capacity than is possible with the largest capacity individual physical space.

In another example, storage controller 104 may configure storage array 106 as a redundant array of disks where a redundant disk is added to the array. This may allow redundant data to be stored on one or more of the disks of the array. In this manner, even if one of the disks in storage array 106 fails, the storage controller may still be able to provide the requested data of the logical disk to host 102. In this case, when storage array 106 is in a redundant state, that is, when none of the disks of the storage array have failed, the array is said to be fault tolerant because it may be able to withstand one disk failure and still be able to provide user data. Some examples of redundant data configurations include mirrored data and parity data.

In another example, storage controller 104 may configure storage array 106 as a RAID configuration. There are several forms or levels of RAID such as RAID level 0 which includes a striped array configuration. In a RAID level 1, the storage array employs disk mirroring where the array includes a pair of disks. In this configuration, each write operation or command, storage controller 104 writes the data to both of the disks in the pair in order to maintain mirrored copies of the data on the pair of disks. On the other hand, each time read commands are issued, storage controller 104 reads only one of the disks. In this configuration, if one disk of storage array 106 fails, storage controller 104 may read data from the remaining disk in the storage array.

In another example, storage controller 104 may configure storage array 106 as a RAID level 4 configuration. In this configuration, storage controller 104 configures storage array 106 to include striping with parity such as four disk array where three of the disks are data disks and the fourth disk is a parity disk. The storage controller 104 may store parity (using Exclusive-OR function) of the first blocks of the three data disks onto blocks of the parity disk. When storage controller 104 writes one or more of the data disks, it calculates the parity of all the data in the corresponding blocks of all the data disks and writes the parity to the corresponding block of the parity disk. On the other hand, when storage controller 104 reads data from storage array 106, it reads from the data disks and not the parity disk. In this configuration, if one of the data disks in storage array 106 fails, storage controller 104 may recreate the data on the failed data disk by reading from the remaining data disks and from the parity disk and binary exclusive-OR the data together. In this manner, storage controller 104 may return the user data to host 102 even when a data disk has failed.

As explained above, when a disk drive in a redundant configuration fails, storage array 106 may no longer be considered fault-tolerant, that is, it may not be able to tolerate a failure of a second disk. In this case, when storage controller 104 is notified of the failure, the storage controller may begin to generate background data commands to restore or rebuild a redundant array of disks from a non-fault-tolerant (or non-fully redundant) state to its fault-tolerant (or fully redundant) state. For example, storage controller 104 may generate commands to recreate the data on the failed disk to a new disk to be included in the array. In one example, for storage array 106 with a parity-redundant data configuration, the storage controller may recreate the data of the failed disk by providing commands that read the data from the remaining disks and performing Exclusive-OR (XOR) functions on the data together. On other hand, for a mirrored-redundant storage array, storage controller 104 may recreate the data of the failed disk by generating commands to read the data from the mirror disk associated with the failed disk. In this manner, when storage controller 104 recreates the data, writes it to the new disk, and logically replaces the failed disk with the new disk into the array, storage array 106 may be considered restored to fault-tolerance or full redundant state.

In some examples of the present application, storage controller 104 includes a storage device queue 116 and a data operation management module 110 to manage data operations. To illustrate operation, in some examples, storage array 106 may be configured as a RAID configuration. Further, to illustrate operation, in one example, it may be assumed that storage array 106 encounters a disk failure which requires a rebuild operation. A rebuild operation may involve a complete storage device replacement of the failed device and recreation of or regeneration of the data from the failed device to the replacement device. Upon replacement of the device that failed, storage controller 104 regenerates the data that is missing from the failed device onto the new replaced device. A rebuild operation may require multiple cycles, such as 1000s of cycles, of background time periods to complete. In this case, storage controller 104 may be notified of the disk failure and respond by initiating background time periods to perform background data operations that include generation of rebuild commands that perform operations which are sequential in nature.

In operation, to illustrate, in one example, data operation management module 110 may be configured to generate host data operation commands 112 in response to receipt of host data requests from host 102. The data operation management module 110 may be configured to generate background commands 114 in response to background data requests. The background data requests may include rebuild requests in response to disk failures of storage array 106 configured as RAID. The data operation management module 110 may include decision logic or functionality (block 124) to determine whether storage controller 104 is operating during a background time period. The management module 110 may have initiated a background time period to provide exclusive access to storage to perform background data operations such as rebuild operations.

If storage controller 104 determines that is not operating during a background time period, rather it is operating in a host time period for exclusive use by host data operations (shown by NO), then management module 110 queues or stores any background data operation commands 114 to storage device queue 116 shown by arrow 122. In addition, management module 110 retrieves any host data operation commands 112 from storage queue 116 as shown by arrow 120 and sends them to storage array as shown by arrow 126. On the other hand, if storage controller 104 determines that is operating during a background time period (shown by YES), then data operation management module 110 may queue or store any host data operation commands 112 to storage device queue 116 as shown by arrow 118. In addition, during the background time period, management module 110 retrieves any background data operation commands 114 from storage queue 116 as shown by arrow 120 and sends them to storage array as shown by arrow 126.

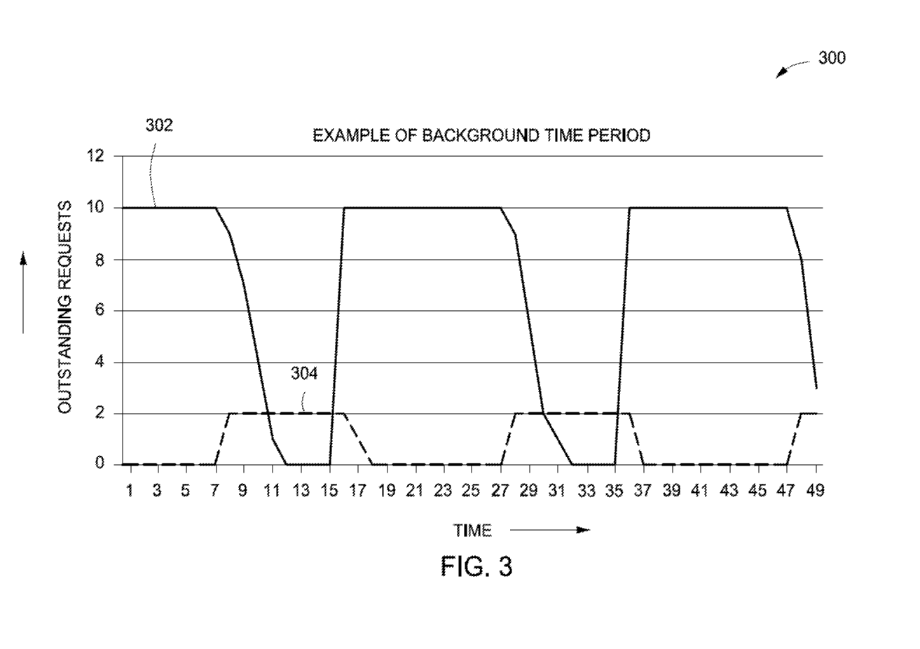

In another example, to illustrate operation, storage controller 104 may be configured to send host data operation commands 112 to LUNs associated with storage devices 108 of storage array 106. This may be referred to as a host time period where storage controller 104 is providing exclusive access to host commands to storage array 106 as host data operations 302 from time t1 to t7 as shown in FIG. 3.

Upon entering a background time period, storage controller 102 allows or permits completion of any outstanding host data operations associated with host data operation commands 112 that were sent to storage devices 108 of storage array 106. This may be referred to as entry or beginning transition period where storage controller 104 permits completion of any outstanding host data operations as host data operations 302 from time t7 to t11 as shown in FIG. 3.

During the background time period, storage controller 104 stores in a storage queue 116 any host data operation commands 112. The storage controller 104 may not send any host data operation commands 112 to LUNs associated with the storage devices. Instead, storage controller 104 sends background data operation commands 114 to LUNs associated with the storage devices. This may be referred to as the background time period where storage controller 104 performs background data operations 304 exclusively from time t12 to t15 as shown in FIG. 3

Upon expiration of the background time period, storage controller 104 retrieves host data operations commands 112 previously stored on storage queue 116. The storage controller 104 sends the retrieved host data operation commands 112 to the LUNs associated with the storage devices. However, storage controller 104 does not send background data operation commands 114 to LUNs associated with the storage devices. This may be referred to as a trailing edge or exit transition period from when background data operations are allowed to complete and as host data operations are being performed. This may be referred to as an exit or ending transition time period from time t15 to t18 as shown in FIG. 3. In some examples, the background time period may be repeated until completion of background operations performed are on the storage devices to rebuild or reconstruct the failed storage device.

The storage device queue 116 may be any non-transitory, computer-readable medium corresponding to storage device that stores computer readable data. For example, storage device queue 116 may include one or more of a non-volatile memory, a volatile memory, and/or one or more storage devices. Examples of non-volatile memory include, but are not limited to, EEPROM and ROM. Examples of volatile memory include, but are not limited to, SRAM, and DRAM. Examples of storage devices include, but are not limited to, hard disk drives, compact disc drives, digital versatile disc drives, optical drives, and flash memory devices.

The functionality of the components of system 100 including host 102, storage controller 104 and storage array 106 may be implemented in hardware, software or a combination thereof. It should be understood that the description of system 100 is for illustrative purposes and other implementations of the system may be employed to practice the techniques of the present application. For example, system 100 is shown as having a storage controller 104 coupled between host 102 and storage array 106. However, system 100 may have a plurality of storage controllers 104 coupled between a plurality of hosts 102 and plurality of storage arrays 106.

In this manner, these techniques may help manage both host data operations and background data operations to help improve overall performance of the storage system.

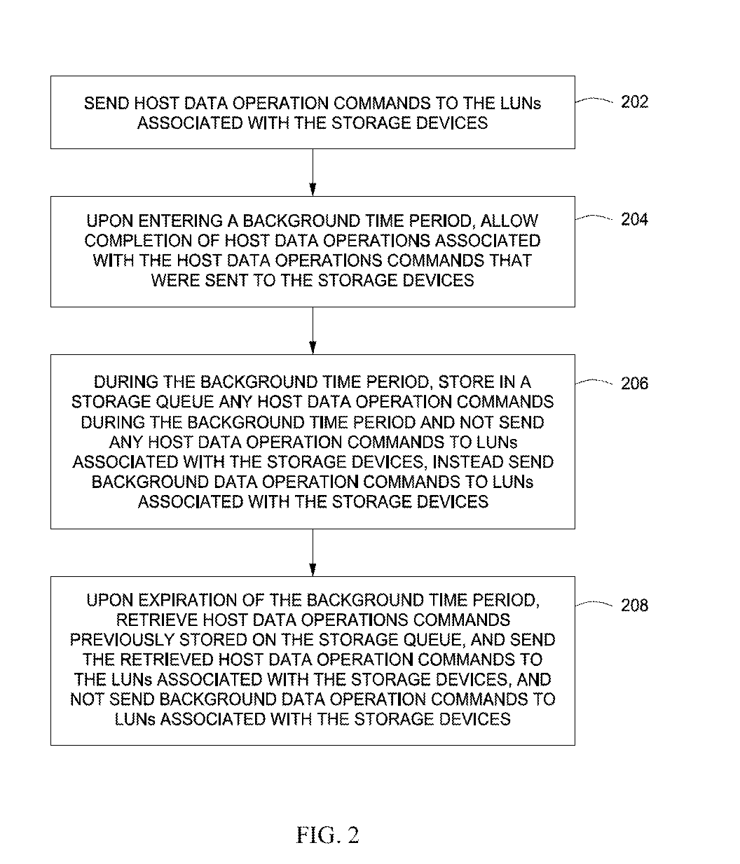

FIG. 2 is a flow diagram of a computer system for management of data operations of FIG. 1 according to an example implementation. FIG. 3 is a timing diagram 300 of a computer system, such as system 110 of FIG. 1, for management of data operations according to an example implementation. FIG. 3 shows host data operation commands or operations as a solid line 302 while background data operation commands or operations as dashed line 304. The below example is described in conjunction with both FIG. 2 and FIG. 3. In one example, it may be assumed that storage controller 104 is coupled between host 102 and storage array 106, as shown in FIG. 1. It may be further assumed that storage array 106 is configured as a RAID configuration and that it encountered a disk failure which requires a rebuild operation. In this case, storage controller 104 responds to the disk failure by initiating background time periods sufficient to perform background data operations sufficient to perform the necessary rebuild data operations.

At block 202, storage controller 104 sends host data operation commands 112 to the LUNs associated with storage devices 108 of storage array 106. The host data operation commands 112 may include read commands to read data from storage array 106 and return the data to host 102. The host data operation commands 112 may include write commands to write data from host 102 to storage array 106. This may be referred to as a host time period where storage controller 104 is providing exclusive access to host commands to storage array as shown as host data operations 302 from time t1 to t7 as shown in FIG. 3. Processing proceeds to block 204.

At block 204, storage controller 104, upon entering a background time period, allows completion of host data operations associated with the host data operation commands 112 that were sent to storage devices 108. This may be referred to as a leading edge or entry transition period from when host data operations 302 are allowed to complete and as background data operations 304 are beginning from time t7 to t11 as shown in FIG. 3. Processing proceeds to block 206.

At block 206, during the background time period, storage controller 104 stores in storage queue 116 any host data operation commands 112 during the background time period. During the background time period, storage controller 104 may not send any host data operation commands 112 to LUNs associated with the storage devices. Instead, during the background time period, storage controller 104 sends background data operation commands 114 to LUNs associated with the storage devices. As shown in FIG. 3, this may be referred to as the background time period where storage controller 104 performs background data operations 304 exclusively from time t12 to t15 as shown in FIG. 3. Processing proceeds to block 208.

At block 208, upon expiration of the background time period, storage controller 104 retrieves host data operations commands previously stored on storage queue 116. Further, upon expiration of the background time period, storage controller 104 sends the retrieved host data operation commands 112 to the LUNs associated with the storage devices. However, upon expiration of the background time period, storage controller 104 may not send background data operation commands 114 to LUNs associated with the storage devices. As shown in FIG. 3, this may be referred to as a trailing edge or exit transition time t15 to t18 when background data operations 304 are allowed to complete and host data operations 302 are being performed. In some examples, processing may proceed back to block 202 where the background time period may be repeated until completion of background operations performed are on the storage devices to rebuild or reconstruct the failed storage device.

In another example, to illustrate operation, it may be assumed that storage devices 108 comprise hard disk drives. In this case, storage controller 104 partitions or parcels out access time to the disk drives with exclusive access periods. These may include background time periods for exclusive use for background data operations. The storage controller 104 may partition the remaining non-background time period for exclusive use for host data operations. This may include host time periods for exclusive use for host data operations. In this manner, the storage system may achieve higher overall efficiency. In contrast, some systems may generate sequential data operations which may cause the system to thrash between background and host data operations. On the other hand, in the techniques of the present application, storage controller 104 parcels out two exclusive access periods, that is background time period and host time period, which may help reduce thrashing between backgrounds and host data operations.

In this manner, these techniques may provide host 102 with exclusive access periods with may provide a higher overall quality of service and higher average and guaranteed quality of service for the reminder time period. In this case, storage controller 104 may make a trade-off between instantaneous performance and higher average performance. In general, the maximum time to complete background operations may be higher but the average time to complete may be lower. In one example, storage controller may provide 80% of the time for exclusive access to storage devices and is not competing with storage controller process. On the other hand, storage controller may provide 20% of the remaining time to not compete with the host process. Here, storage controller 104 partitions access time between when host 102 exclusive access to storage devices and when background data operations for storage controller 104 exclusive access.

In this manner, these techniques may help manage both host data operations and background data operations to help improve overall performance of the storage system.

It should be understood that the above process is for illustrative purposes and that other implementations may be employed to the practice the techniques of the present application. For example, the storage controller may adjust periodicity of the background time period and length of the background time period based on characteristics of host data operations and background data operations.

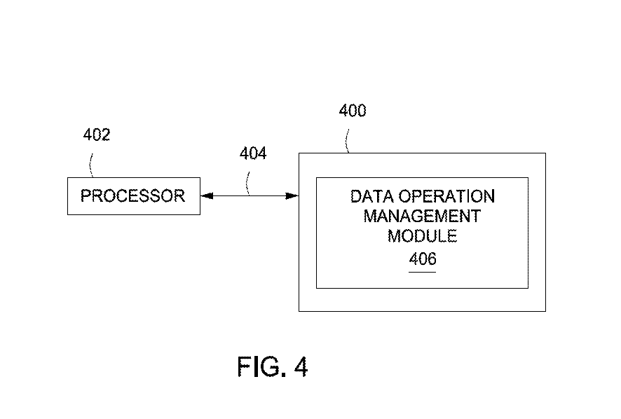

FIG. 4 is an example block diagram showing a non-transitory, computer-readable medium that stores instructions for a computer system for read-ahead processing in accordance with an example implementation. The non-transitory, computer-readable medium is generally referred to by the reference number 400 and may be included in devices of system 100 as described herein. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, EEPROM and ROM. Examples of volatile memory include, but are not limited to, SRAM, and DRAM. Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to operate the devices of system 100 in accordance with an example. In an example, the tangible, machine-readable medium 400 may be accessed by the processor 402 over a bus 404. A first region 406 of the non-transitory, computer-readable medium 400 may include data operation management functionality as described herein.

Although shown as contiguous blocks, the software components may be stored in any order or configuration. For example, if the non-transitory, computer-readable medium 400 is a hard drive, the software components may be stored in non-contiguous, or even overlapping, sectors.

What is claimed is:

1. A method of management of data operations, the method comprising:
In response to receipt of host data operation requests associated with logical unit numbers (LUNs) of storage devices, sending host data operation commands to the LUNs associated with the storage devices;
upon entering a background time period, allowing completion of host data operations associated with the host data operations commands that were sent to the storage devices;
during the background time period, storing in a storage queue any host data operation commands during the background time period and not sending any host data operation commands to LUNs associated with the storage devices, instead sending background data operation commands to LUNs associated with the storage devices; and
upon expiration of the background time period, retrieving host data operations commands previously stored on the storage queue, and sending the retrieved host data operation commands to the LUNs associated with the storage devices, and not sending background data operation commands to LUNs associated with the storage devices.

2. The method of claim 1, wherein the background time period is repeated until completion of background operations performed on the storage devices.

3. The method of claim 1, wherein the host data operation commands includes commands to exchange data between the host and the storage devices.

4. The method of claim 1, wherein the background data operation commands include commands to perform at least one of sequential data operations and random data operations on the storage devices.

5. The method of claim 1, further comprising adjusting periodicity of the background time period and length of the background time period based on characteristics of host data operations and background data operations.

6. An apparatus for management of data operations, the apparatus comprising:
a storage device queue to manage data operations; and
a data operation management module to:
In response to receipt of host data operation requests associated with logical unit numbers (LUNs) of storage devices, send host data operation commands to the LUNs associated with the storage devices,
upon entering a background time period, allow completion of host data operations associated with the host data operations commands that were sent to the storage devices,
during the background time period, store in a storage queue any host data operation commands during the background time period and not send any host data operation commands to LUNs associated with the storage devices, instead send background data operation commands to LUNs associated with the storage devices, and
upon expiration of the background time period, retrieve host data operations commands previously stored on the storage queue, and send the retrieved host data operation commands to the LUNs associated with the storage devices, and not send background data operation commands to LUNs associated with the storage devices.

7. The apparatus of claim 6, wherein the data operation management module is configured to repeat the background time period until completion of background operations performed on the storage devices.

8. The apparatus of claim 6, wherein the host data operation commands includes commands to exchange data between the host and the storage devices.

9. The apparatus of claim 6, wherein the background data operation commands include commands to perform at least one of sequential data operations and random data operations on the storage devices.

10. The apparatus of claim 6, wherein the data operation management module further configured to adjust periodicity of the background time period and length of the background time period based on characteristics of host data operations and background data operations.

11. An article comprising a non-transitory computer readable storage medium to store instructions for management of data operations that when executed by a computer to cause the computer to:
In response to receipt of host data operation requests associated with logical unit numbers (LUNs) of storage devices, send host data operation commands to the LUNs associated with the storage devices;
upon entering a background time period, allow completion of host data operations associated with the host data operations commands that were sent to the storage devices;
during the background time period, store in a storage queue any host data operation commands during the background time period and not send any host data operation commands to LUNs associated with the storage devices, instead send background data operation commands to LUNs associated with the storage devices; and
upon expiration of the background time period, retrieve host data operations commands previously stored on the storage queue, and send the retrieved host data operation commands to the LUNs associated with the storage devices, and not send background data operation commands to LUNs associated with the storage devices.

12. The article of claim 11, further comprising instructions that if executed cause a computer to repeat background time periods until completion of background operations performed on the storage devices.

13. The article of claim 11, further comprising instructions that if executed cause a computer to generate host data operation commands that includes commands to exchange data between the host and the storage devices.

14. The article of claim 11, further comprising instructions that if executed cause a computer to generate host data operation commands that includes commands to exchange data between the host and the storage devices.

15. The article of claim 11, further comprising instructions that if executed cause a computer to adjust periodicity of the background time period and length of the background time period based on characteristics of host data operations and background data operations.
